(19) United States
(12) Patent Application Publication
(10) Pub. No.: US 2020/0019307 A1
(43) Pub. Date: Jan. 16, 2020

(54) SYMBOL INPUT DEVICE AND SYMBOL INPUT CONTROL METHOD

(71) Applicant: KYOCERA Document Solutions Inc., Osaka (JP)

(72) Inventor: Naoki SAWA, Osaka-shi (JP)

(73) Assignee: KYOCERA Document Solutions Inc., Osaka (JP)

(21) Appl. No.: 16/451,939

(22) Filed: Jun. 25, 2019

(30) Foreign Application Priority Data
Jul. 10, 2018 (JP) 2018-130603

(51) Int. Cl. G06F 3/0488; G06F 3/01

(52) U.S. Cl. CPC G06F 3/04886; G06F 3/018

(57) ABSTRACT

In a symbol input device, a receiving section receives a symbol input instruction to input a symbol through a software keyboard image. A processor switchingly executes a non-conversion mode and a conversion mode. The symbol includes a first phonogram of a first language and a second phonogram of a second language. A first software keyboard image includes a consonant key image and a first vowel key image. A second software keyboard image includes a consonant key image, and a second vowel key image, instead of the first vowel key image, representing a second vowel character corresponding to a first vowel character. The processor controls a display to display the second software keyboard image in the conversion mode.

### INCORPORATION BY REFERENCE

The present application claims priority under 35 U.S.C. § 119 to Japanese Patent Application No. 2018-130603, filed on Jul. 10, 2018. The contents of this application are incorporated herein by reference in their entirety.

### BACKGROUND

The present disclosure relates to a symbol input device and a symbol input control method.

There are known information processing apparatuses in which a character is input using a keyboard displayed on a touch panel. In some of these information processing apparatuses, a keyboard including English alphabets arranged in alphabetical order is displayed when a user inputs English characters. In other information processing apparatuses, a keyboard including Japanese kana characters arranged in Japanese syllabary order is displayed when a user inputs Japanese characters.

### SUMMARY

A symbol input device according to the present disclosure includes a display, a receiving section, and a processor. The display displays a software keyboard image and a symbol input through the software keyboard image. The receiving section receives a symbol input instruction. The processor switchingly executes a non-conversion mode and a conversion mode. In accordance with the symbol input instruction, the symbol is input through the software keyboard image. The symbol includes a first phonogram representing a phonogram of a first language and a second phonogram representing a phonogram of a second language different from the first language. The first phonogram includes a consonant character and a first vowel character. The second phonogram includes a second vowel character corresponding to the first vowel character. The non-conversion mode is a mode in which the first phonogram input in accordance with the symbol input instruction is displayed on the display. The conversion mode is a mode in which the first phonogram input in accordance with the symbol input instruction is converted into the second phonogram corresponding to the first phonogram to be displayed on the display. The software keyboard image includes a first software keyboard image and a second software keyboard image. The first software keyboard image includes a consonant key image representing the consonant character and a first vowel key image representing the first vowel character. The second software keyboard image includes the consonant key image and a second vowel key image representing the second vowel character instead of the first vowel key image. The processor controls the display to display the second software keyboard mage in the conversion mode.

A symbol input control method according to the present disclosure includes causing a processor to execute switchingly executing, displaying, and receiving. In the switchingly executing, a non-conversion mode and a conversion mode are switchingly executed. In the displaying, a software keyboard image and a symbol input through the software keyboard image are displayed. In the receiving, a symbol input instruction is received. In accordance with the symbol input instruction, the symbol is input through the software keyboard image. The symbol includes a first phonogram representing a phonogram of a first language and a second phonogram representing a phonogram of a second language different from the first language. The first phonogram includes a consonant character and a first vowel character. The second phonogram includes a second vowel character corresponding to the first vowel character. The non-conversion mode is a mode in which the first phonogram input in accordance with the symbol input instruction is displayed in the displaying. The conversion mode is a mode in which the first phonogram input in accordance with the symbol input instruction is converted into the second phonogram corresponding to the first phonogram to be displayed in the displaying. The software keyboard image includes a first software keyboard image and a second software keyboard image. The first software keyboard image includes a consonant key image representing the consonant character and a first vowel key image representing the first vowel character. The second software keyboard image includes the consonant key image and a second vowel key image representing the second vowel character instead of the first vowel key image. In the switchingly executing, the second software keyboard image is displayed in the conversion mode.

### BRIEF DESCRIPTION OF THE DRAWINGS

FIG. 1A is a configuration diagram illustrating a symbol input device according to an embodiment of the present disclosure, and FIG. 1B is a diagram illustrating the symbol input device.

FIG. 2 is another diagram illustrating the symbol input device.

FIGS. 3A, 3B, 3C, 3D, 3E, and 3F are diagrams each illustrating a part of the symbol input device.

FIGS. 4A and 4B are diagrams illustrating the symbol input device.

FIGS. 5A and 5B are other diagrams illustrating the symbol input device.

FIG. 6 is a diagram illustrating the symbol input device.

FIG. 7 is another diagram illustrating the symbol input device.

FIG. 8 is a flowchart illustrating switching display processing for a software keyboard image.

### DETAILED DESCRIPTION

Now, embodiments of the present disclosure will be described with reference to the accompanying drawings. It is noted that the same or corresponding elements illustrated in the drawings are referred to using the same reference signs to avoid repetition of the description.

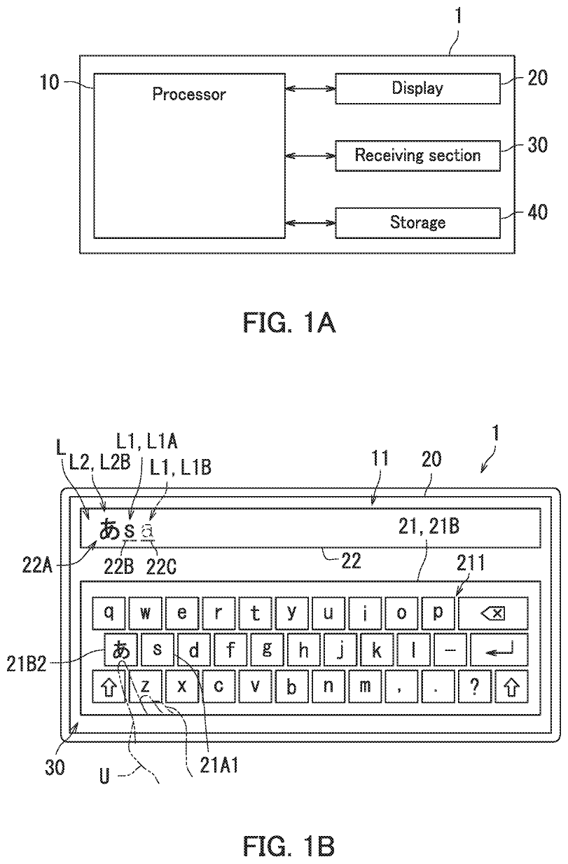

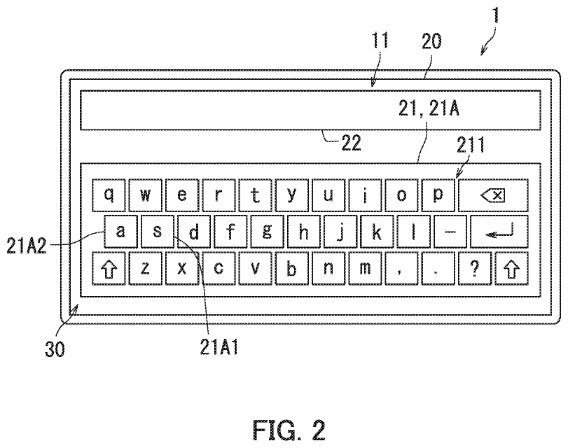

Referring to FIGS. 1A, 1B and 2, an embodiment of a symbol input device 1 according to the present disclosure will be described. FIG. 1A is a configuration diagram illustrating the symbol input device 1. FIG. 1B and FIG. 2 are diagrams illustrating the symbol input device 1. The symbol input device 1 is, for example, a tablet PC, a smartphone, or a personal computer. Alternatively, the symbol input device 1 may be an operation panel (such as a touch panel device including a display) provided in an image forming apparatus (such as a multifunction peripheral). In the following, an embodiment in which the symbol input device 1 is a tablet PC will be described.

As illustrated in FIG. 1A, the symbol input device 1 includes storage 40, a processor 10, a display 20, and a receiving section 30.

The storage 40 is constructed from, for example, a hard disk drive (HDD), random-access memory (RAM), and read only memory (ROM). The storage 40 may include external memory. The external memory is a removable medium. The storage 40 includes, for example, a secure digital (SD) card as the external memory. The storage 40 stores therein various data, a control program, and an application program. The control program is a program for controlling operations of respective sections of the symbol input device 1, and is executed by the processor 10.

The processor 10 is a hardware circuit such as a central processing unit (CPU), and functions as a controller. The processor 10 controls the operations of the respective sections of the symbol input device 1 by reading and executing the control program stored in the storage 40. Besides, the processor 10 reads and executes the application program stored in the storage 40. The processor 10 includes a timer circuit capable of measuring time.

As illustrated in FIG. 1B, the display 20 constitutes, for example, a display section having a touch panel function, and is disposed on a surface of a housing of the symbol input device 1. Such a display 20 also works as the receiving section 30. The display 20 is, for example, a liquid crystal display, or an organic electroluminescent display (organic EL display).

The display 20 displays a software keyboard image 21 and a symbol L. In detail, the display 20 includes a screen and a touch sensor, and displays various types of images on the screen. The various types of images correspond, for example, to the software keyboard image 21, an image corresponding to the symbol L (hereinafter sometimes simply referred to the “symbol L”), or various types of operation screen images.

The software keyboard image 21 is an image representing a software keyboard having a key layout 211. The key layout 211 is, for example, a QWERTY layout, a DVORAK layout, an AZERTY layout, or a QWERTZ layout. It is noted that the key layout 211 is assumed to be the QWERTY layout in the embodiment described below. The symbol L is input through the software keyboard image 21 in accordance with an operation performed by a user. The input symbol L is displayed in an input symbol display area 22 in the whole screen area of the display 20. The software keyboard image 21 is disposed, for example, adjacently to the input symbol display area 22.

The symbol L includes a first phonogram L1 and a second phonogram L2. In detail, the first phonogram L1 represents a phonogram of a first language. The first language is, for example, English, French, or German. The second phonogram L2 represents a phonogram of a second language. The second language is different from the first language. In the present embodiment, when the first language is, for example, English, and the second language is, for example, Japanese or Korean. A phonogram refers to a character corresponding to each phonetic unit. A phonogram is, for example, each character of English alphabets, each character of Japanese kana characters (Japanese alphabets), or each character of Hangul characters. It is noted that the following embodiment will be described assuming an exemplary case where the first language is English and the second language is Japanese.

The first phonogram L1 includes a first consonant character L1A and a first vowel character L1B. The first consonant character L1A corresponds to a “consonant character”. For example, in the embodiment where the first language is English, the first phonogram L1 is any character of the English alphabets (any of “a” to “z”). The first consonant character L1A is, for example, “s”, “p”, or “b”. The first vowel character L1B is “a”, “i”, “u”, “e”, or “o”.

The second phonogram L2 includes a second consonant character and a second vowel character L2B. For example, in the embodiment where the second language is Japanese, the second phonogram L2 is any character of Japanese kana characters. The Japanese kana characters are, for example, fifty Japanese kana characters of the Japanese syllabary of hiragana or katakana. The second consonant character is, for example, “ [symbol] ”, “ [symbol] ”, “ [symbol] ”, “ [symbol] ”, or “ [symbol] ”. The second vowel character L2B corresponds to the first vowel character L1B. Specifically, in the embodiment where the first vowel character L1B is “a”, “i”, “u”, “e”, “o”, the second vowel character L2B is respectively, for example, “ [symbol] ”, “ [symbol] ”, “ [symbol] ”, “ [symbol] ”, or “ [symbol] ” of hiragana.

The receiving section 30 receives various instructions in accordance with operations performed by a user. The operations performed by a user are, for example, a tap operation and a flick operation. In detail, the receiving section 30 is, for example, a touch panel. The various instructions are, for example, instructions for various settings or a symbol input instruction U. The instructions for various settings are instructions for changing various settings of the symbol input device 1. The symbol input instruction U is an instruction to input the symbol L through the software keyboard image 21.

The processor 10 switchingly executes a non-conversion mode and a conversion mode 11. The non-conversion mode and the conversion mode 11 are switched therebetween, for example, when a user taps a prescribed switch key. The non-conversion mode is a mode where the first phonogram L1 input in accordance with the symbol input instruction U is displayed on the display 20. The non-conversion mode is, for example, an alphanumeric character input mode. Specifically, in the non-conversion mode, the processor 10 displays the input first phonogram L1 (for example, “p”) in the input symbol display area 22 without conversion, and determines a display state of the first phonogram L1 (for example, “p”).

The conversion mode 11 is a mode where the first phonogram L1 input in accordance with the symbol input instruction U is converted into the second phonogram L2 corresponding to the first phonogram L to be displayed on the display 20. The conversion mode 11 is, for example, a romaji (roman alphabets) input mode. The romaji input mode refers to a mode where Japanese is input by combining a consonant and a vowel of romaji. Specifically, in the conversion mode 11, the processor 10 converts the input first phonogram L1 into the second phonogram L2 in accordance with a romanization method (such as a Hepburn romanization method) to be displayed in the input symbol display area 22, and determines the display state of the second phonogram L2.

For example, when a character “a” is input as the first vowel character L1B in the conversion mode 11, the display 20 convers the character “a” into a character “ [symbol] ” of the second vowel character L2B, and displays the character “ [symbol] ” in a determinate state 22A in the input symbol display area 22.

For example, when a character “s” is input as the first consonant character L1A in the conversion mode 11, the display 20 displays the character “s” in an indeterminate state 22B in the input symbol display area 22. Subsequently, when the character “a” is, for example, input in a position of a cursor 22C as the first vowel character L1B, the display 20 convers the characters “sa” into a character “ [symbol] ” (not shown) as the second consonant character, and displays the character “ [symbol] ” in the determinate state 22A in the input symbol display area 22.

In the conversion mode 11, the processor 10 controls the display 20 so as to display a second software keyboard image 21B as the software keyboard image 21. In detail, the software keyboard image 21 includes a first software keyboard image 21A (FIG. 2) and the second software keyboard image 21B (FIG. 1B).

As illustrated in FIG. 2, the first software keyboard image 21A includes a consonant key image 21A1 and a first vowel key image 21A2. The consonant key image 21A1 is an image of a key indicating the first consonant character L1A (for example, “s” key). The first vowel key image 21A2 is an image of a key indicating the first vowel character L1B (for example, “a” key).

As illustrated in FIG. 1B, the second software keyboard image 21B includes the consonant key image 21A1 and a second vowel key image 21B2 instead of the first vowel key image 21A2. The second vowel key image 21B2 is an image of a key indicating the second vowel character L2B. The key indicating the second vowel character L2B is, for example, a key indicating the character “ [symbol] ”.

As described so far with reference to FIGS. 1A, 1B and 2, according to the present embodiment, the symbol input device 1 includes the processor 10, the receiving section 30, and the display 20. The processor 10 switchingly executes the non-conversion mode and the conversion mode 11. The receiving section 30 receives the symbol input instruction U. The display 20 displays the software keyboard image 21 and the symbol L input in accordance with the symbol input instruction U. The software keyboard image 21 includes the first software keyboard image 21A and the second software keyboard image 21B. The first software keyboard image 21A includes the consonant key image 21A1 and the first vowel key image 21A2. The second software keyboard image 21B includes the consonant key image 21A1 and the second vowel key image 21B2 instead of the first vowel key image 21A2. The processor 10 controls the display 20 to display the second software keyboard image 21B in the conversion mode 11.

In this manner, a user can input a character while visually checking the keyboard in which the key of the first vowel character L1B is replaced with the key of the second vowel character L2B corresponding to the first vowel character L1B. Accordingly, uncomfortableness that a user used to use a keyboard of a general key layout feels due to the key layout in inputting a character in the conversion mode 11 can be reduced. As a result, in inputting a phonogram through the software keyboard image 21, it can be easily perceived whether or not an input phonogram is converted.

Besides, according to the present embodiment, the first phonogram L1 can be an English alphabet. Furthermore, the software keyboard image 21 can represent the software keyboard of the QWERTY layout. Accordingly, when the conversion mode 11 using an English alphabet is executed with the keyboard of the widely used key layout, a user can easily perceive whether or not an input English alphabet is converted.

Furthermore, according to the present embodiment, the second language can be Japanese, and the second phonogram L2 can be a Japanese kana character. Besides, the conversion mode 11 can indicate the romaji input mode. Accordingly, when a user inputs the first phonogram L1, the user can intuitively perceive, while visually checking the key layout 211 corresponding to the input character without uncomfortableness, whether the current mode is the romaji input mode or the non-conversion mode. As a result, an eye movement distance necessary for checking the setting of the romaji input mode can be reduced.

Besides, the processor 10 controls the display 20 preferably in such a manner that the first software keyboard image 21A and the second software keyboard image 21B can be switched therebetween based on the symbol input instruction U in the conversion mode 11. The processing for switchingly displaying the first software keyboard image 21A and the second software keyboard image 21B by the processor 10 may be set by default, or a user may change the setting in accordance with convenience for an operation for inputting a character. Hereinafter, processing for controlling, by the processor 10, the display 20 to switchingly display the first software keyboard image 21A and the second software keyboard image 21B is sometimes referred to as the “switching display processing”. When the first software keyboard image 21A and the second software keyboard image 21B are thus switched therebetween, user's preferences in the keyboard operation can be flexibly coped with.

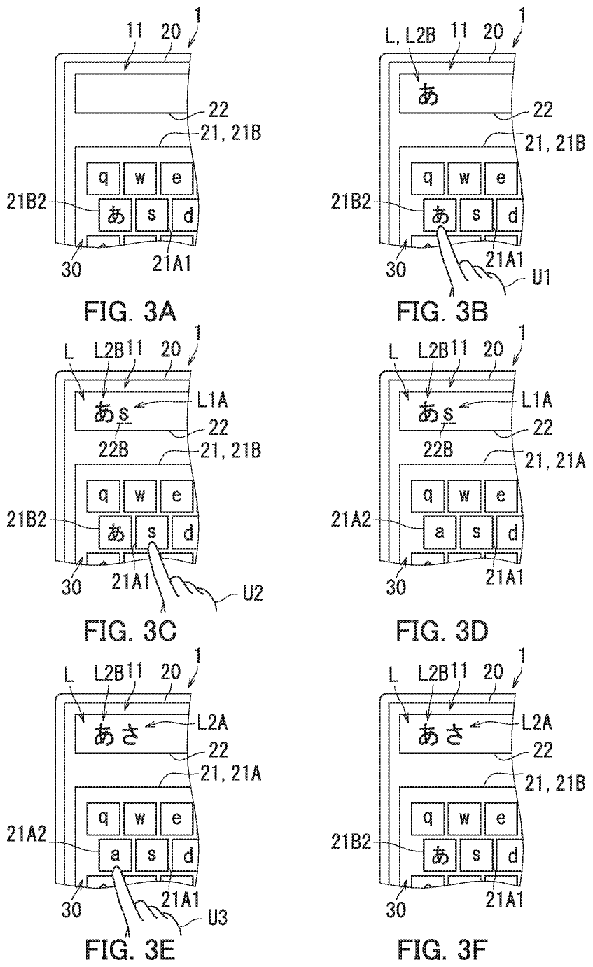

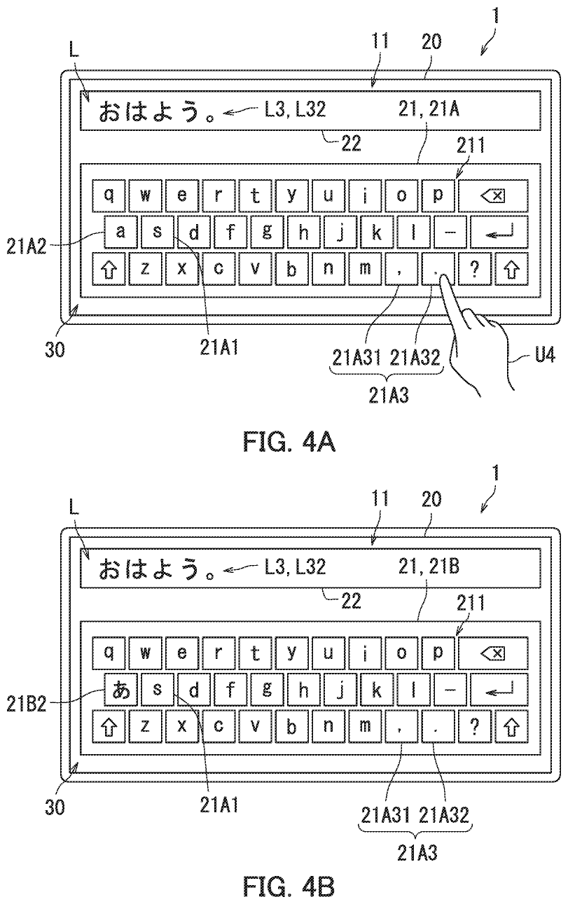

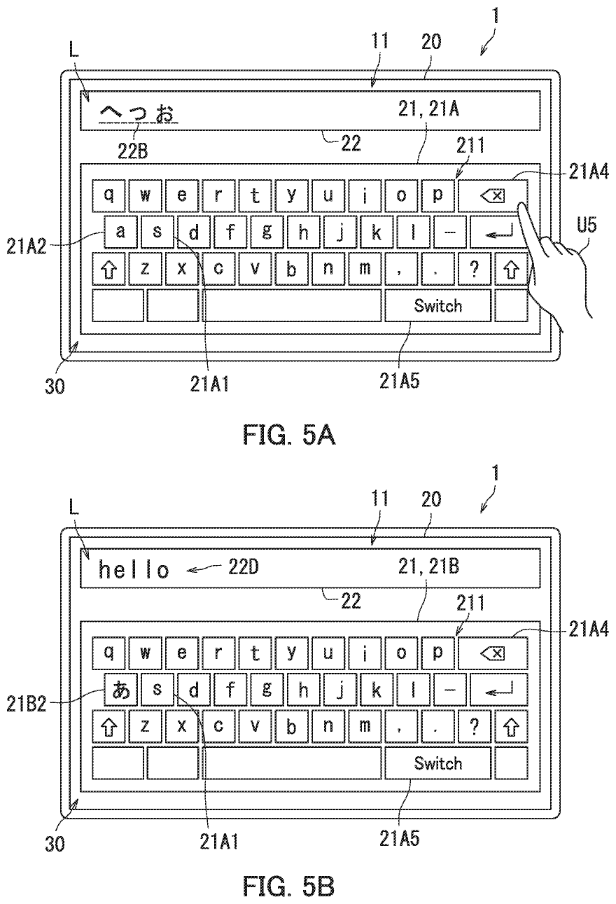

Subsequently, referring to FIGS. 1A, 1B, and 2, and further FIGS. 3A to 5B, an example of the switching display processing will be described. FIGS. 3A, 3B, 3C, 3D, 3E, and 3F are diagrams each illustrating a part of the symbol input device 1. FIGS. 4A, 4B, 5A, and 5B are diagrams illustrating the symbol input device 1.

As illustrated in FIGS. 3A to 3F, the symbol input instruction U preferably includes a second vowel input instruction U1, a consonant input instruction U2, and a first vowel input instruction U3. The second vowel input instruction U1 is an instruction to input the second vowel character L2B. The consonant input instruction U2 is an instruction to input the first consonant character L1A. The first vowel input instruction U3 is an instruction to input the first vowel character L1B.

Specifically, as illustrated in FIG. 3A, when the conversion mode 11 is selected from the non-conversion mode and the conversion mode 11 in accordance with an operation performed by a user, the display 20 displays the second software keyboard 21B. Now, referring to FIGS. 3B to 3F, a case of displaying the second vowel character L2B “ [symbol] ” and the second consonant character L2A “ [symbol] ” in the input symbol display area 22 will be exemplified.

As illustrated in FIG. 3B, the receiving section 30 receives the second vowel input instruction U1. The second vowel input instruction U1 indicates a tap operation on the second vowel key image 21B2. The second vowel key image 21B2 is, for example, a key image representing “ [symbol] ”. The display 20 displays the second vowel character L2B in the input symbol display area 22 in accordance with the second vowel input instruction U1. The second vowel character L2B is, for example, “ [symbol] ”.

Next, as illustrated in FIG. 3C, the display 20 maintains the display of the second software keyboard image 21B. Besides, the receiving section 30 receives the consonant input instruction U2. The consonant input instruction U2 indicates a tap operation on the consonant key image 21A1. The consonant key image 21A1 is, for example, a key image representing “s”. The display 20 displays the first consonant character LA in the indeterminate state 22B in the input symbol display area 22 in accordance with the consonant input instruction U2. The first consonant character L1A is, for example, “s”.

Next, as illustrated in FIG. 3D, the display 20 switches the second software keyboard image 21B to display the first software keyboard image 21A.

Next, as illustrated in FIG. 3E, the receiving section 30 receives the first vowel input instruction U3. The first vowel input instruction U3 indicates a tap operation on the first vowel key image 21A2. The first vowel key image 21A2 is, for example, a key image representing “a”. The display 20 displays the second consonant character L2A in the input symbol display area 22 in accordance with the first vowel input instruction U3. The second consonant character L2A is, for example, “ [symbol] ”.

Next, as illustrated in FIG. 3F, the display 20 switches the first software keyboard image 21A to display the second software keyboard image 21B.

As described with reference to FIGS. 1A to 3F so far, according to the present embodiment, when the receiving section 30 receives the consonant input instruction U2, the processor 10 switches the second software keyboard image 21B to the first software keyboard image 21A. Accordingly, in the conversion mode 11, a user can smoothly input a character to be combined subsequently to a character having been input in accordance with the consonant input instruction U2.

Besides, when the receiving section 30 receives the first vowel input instruction U3, the processor 10 switches the first software keyboard image 21A to the second software keyboard image 21B. Accordingly, in the conversion mode 11, when an input character is determined in accordance with the first vowel input instruction U3, a user can easily perceive whether or not a phonogram subsequently input is converted.

Furthermore, when the receiving section 30 receives the second vowel input instruction U1, the processor 10 can maintain the display of the second software keyboard image 21B. Accordingly, in the conversion mode 11, when an input character is determined in accordance with the second vowel input instruction U1, a user can easily perceive whether or not a phonogram subsequently input is converted.

Besides, as illustrated in FIG. 4A, the symbol input instruction U preferably further includes a punctuation input instruction U4. The punctuation input instruction U4 is an instruction to input a punctuation mark L3. The punctuation mark L3 is, for example, a full stop “ [symbol] ”, or a comma “ [symbol] ”. Specifically, the punctuation input instruction U4 indicates a tap operation on a punctuation key image 21A3. The punctuation key image 21A3 is, for example, a full stop key image 21A32 or a comma key image 21A31.

The symbol input instruction U preferably further includes a first input instruction and a second input instruction. When the receiving section 30 receives the first input instruction or the second input instruction, the processor 10 switches, for example, the second software keyboard image 21B to the first software keyboard image 21A. The first input instruction is an instruction to input the first phonogram L1. The second input instruction is an instruction to input the second phonogram L2. In other words, the first input instruction and the second input instruction do not include the punctuation input instruction U4. For example, in accordance with the first input instruction and the second input instruction, the symbol L is displayed in the input symbol display area 22. The symbol L is, for example, each character of “ [symbol] ”, “ [symbol] ”, “ [symbol] ”, and “ [symbol] ” of hiragana.

Next, when the receiving section 30 receives the punctuation input instruction U4, the processor 10 switches the first software keyboard image 21A to the second software keyboard image 21B as illustrated in FIG. 4B. A situation where a user inputs the punctuation input instruction U4 is, for example, a situation where the user is to have a rest in many cases. Accordingly, in a case where the punctuation input instruction U4 has been input, when the user resumes to input the symbol L, the user can easily perceive whether or not an input phonogram is converted.

Furthermore, when the receiving section 30 receives the symbol input instruction U (see FIG. 1B), the processor 10 switches the second software keyboard image 21B to the first software keyboard image 21A. When the receiving section 30 has not received another symbol input instruction U for a prescribed period of time after receiving the symbol input instruction U, the processor 10 preferably switches the first software keyboard image 21A to the second software keyboard image 21B. A situation where the receiving section 30 has not received an additional symbol input instruction U for the prescribed period of time is, for example, a situation where a user is taking a rest. Accordingly, in a case where the receiving section 30 has not received an additional symbol input instruction U for the prescribed period of time, when the user resumes to input the symbol L, the user can easily perceive whether or not an input phonogram is converted.

Besides, as illustrated in FIG. 5A, the symbol input instruction U preferably further includes a delete instruction U5. The delete instruction U5 is an instruction to delete the symbol L having been input. When the receiving section 30 receives the delete instruction U5, the processor 10 switches the first software keyboard image 21A to the second software keyboard image 21B as illustrated in FIG. 5B. Specifically, the delete instruction U5 indicates a tap operation on a delete key image 21A4. Therefore, when a user is to correct a character having been input by mistake, the user can easily perceive whether or not the input phonogram is converted.

Furthermore, based on frequency of the receiving section 30 receiving the delete instruction U5, the processor 10 may switch the first software keyboard image 21A to the second software keyboard image 21B to be maintained (to stop the switching display processing to the first software keyboard image 21A). Thus, the number of input mistakes further made by a user having made a large number of input mistakes can be reduced.

Besides, when the receiving section 30 receives the delete instruction U5 in the conversion mode 11, the processor 10 may control the display 20 so as to convert a symbol L displayed in the indeterminate state 22B in the input symbol display area 22 and display the thus converted symbol. The display 20 converts, for example, a symbol L in the indeterminate state 22B as illustrated in FIG. 5A into a symbol L in a converted state 22D as illustrated in FIG. 5B and displays this symbol. The symbol L in the indeterminate state 22B is, for example, each character of “ [symbol] ”, “ [symbol] ”, and “ [symbol] ” of hiragana. The symbol L in the converted state 22D is, for example, each character of “h”, “e”, “l”, “l”, and “o” of the alphabets. Besides, the processor 10 may convert a symbol L based on whether or not a user has performed a tap operation on a switch key image 21A5. The switch key image 21A5 represents a key for switching between the conversion mode 11 and the non-conversion mode. Accordingly, the convenience of performing a correcting operation when a user made an input mistake can be improved.

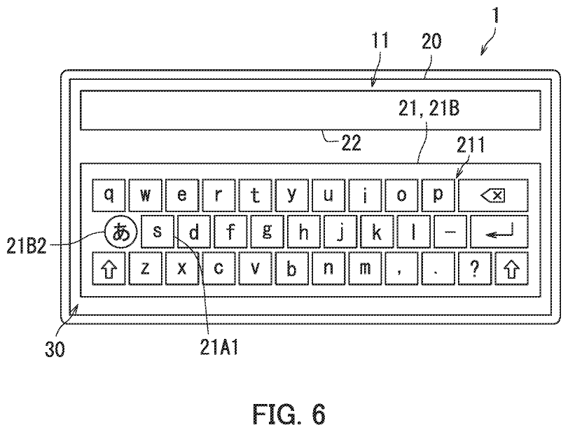

Furthermore, as illustrated in FIG. 6, a form of the second vowel key image 21B2 is preferably different from a form of the first vowel key image 21A2. FIG. 6 is a diagram illustrating the symbol input device 1. For example, when the first vowel key image 21A2 is in the form of a rectangular shape, the second vowel key image 21B2 is in the form of a circular or triangular shape. Alternatively, when the first vowel key image 21A2 is a key in the form with a black character on a white background, the second vowel key image 21B2 is a key in the form with a black character on a yellow background. Accordingly, a user can easily perceive whether or not an input phonogram is converted.

Besides, the first vowel character L1B (see FIG. 1B) is preferably plural in number. Each of the plural first vowel characters L1B represents a corresponding one of a plurality of vowels different from one another. When the first vowel character L1B is plural in number, the second vowel character L2B (see FIG. 1B) is plural in number. In other words, the plural second vowel characters L2B correspond to the respective first vowel characters L1B.

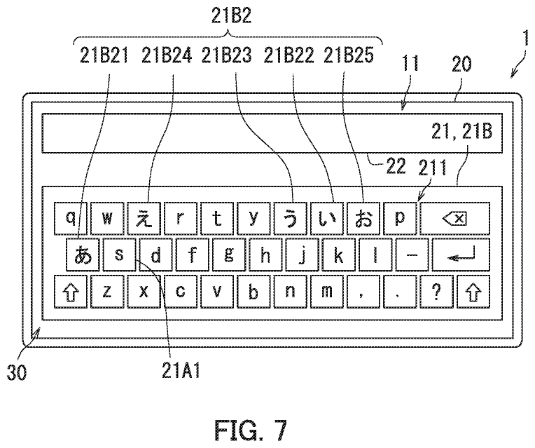

For example, as illustrated in FIG. 7, in the conversion mode 11, the second software keyboard image 21B can include a plurality of second vowel key images 21B2 corresponding to a corresponding one of plurality of second vowel characters L2B. FIG. 7 is a diagram illustrating the symbol input device 1. The plural second vowel key images 21B2 are, for example, second vowel key images 21B21, 21B22, 21B23, 21B24, and 21B25. The second vowel key images 21B21, 21B22, 21B23, 21B24, and 21B25 are respectively the key images of, for example, “ [symbol] ”, “ [symbol] ”, “ [symbol] ”, “ [symbol] ”, and “ [symbol] ”. Specifically, the second software keyboard image 21B includes each of the second vowel key images 21B21 to 21B25 instead of each of the plural first vowel key images 21A2 (for example, key images of “a”, “i”, “u”, “e”, and “o”) (see FIG. 2). Accordingly, a user can easily perceive whether or not an input phonogram is converted.

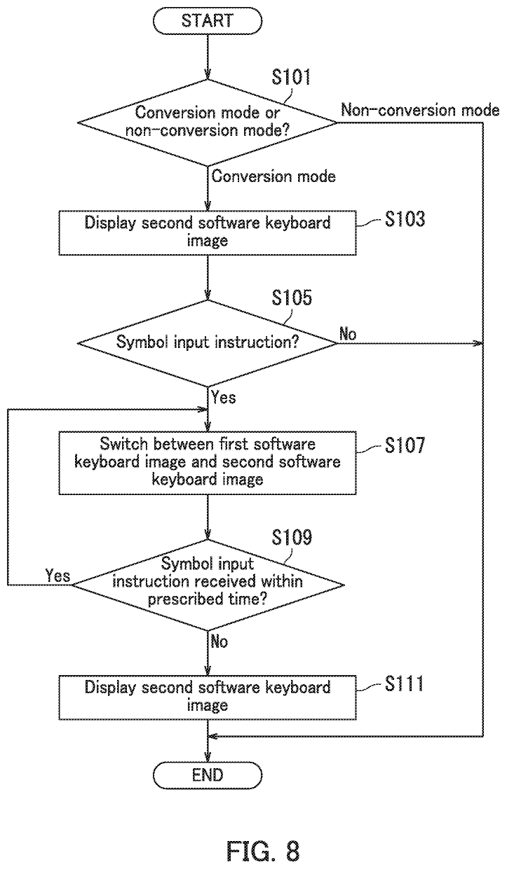

Subsequently, an operation of the symbol input device 1 will be described with reference to FIGS. 1A to 8. FIG. 8 is a flowchart illustrating the switching display processing for the software keyboard image 21. The processor 10 can execute the various switching display processing described with reference to FIGS. 1A to 7 by executing Steps S101 to S111. Specifically, the processing is executed as follows.

In Step S101, the processor 10 determines whether the conversion mode 11 has been selected or the non-conversion mode has been selected. When the conversion mode 11 has been selected (“Conversion Mode” in Step S101), the procedure proceeds to Step S103. On the other hand, when the non-conversion mode has been selected (“Non-conversion Mode” in Step S101), the processor 10 completes the processing.

When the “Conversion Mode” has been selected in Step S101, the display 20 displays the second software keyboard image 21B in Step S103. The procedure proceeds to Step S105.

Next, the processor 10 determines, in Step S105, whether or not the receiving section 30 has received the symbol input instruction U. When the symbol input instruction U has been received (Yes in Step S105), the procedure proceeds to Step S107. On the other hand, when the symbol input instruction U has not been received (No in Step S105), the processor 10 completes the processing.

If Yes in Step S105, the processor 10 switches between the first software keyboard images 21A and the second software keyboard image 21B in Step S107. The procedure proceeds to Step S109.

Next, the processor 10 determines, in Step S109, whether or not the receiving section 30 has received the symbol input instruction U within a prescribed period of time. When the symbol input instruction U has not been received for the prescribed period of time (No in Step S109), the procedure proceeds to Step S111. On the other hand, when the symbol input instruction U has been received within the prescribed period of time (Yes in Step S109), the processor 10 advances the procedure to Step S107, and switches between the first software keyboard image 21A and the second software keyboard image 21B.

If No in Step S109, the display 20 displays, in Step S111, the second software keyboard image 21B. Then, the processing ends.

The embodiments of the present disclosure have been described so far with reference to the accompanying drawings (FIGS. 1A to 8). It is noted that the present disclosure is not limited to the aforementioned embodiments, and can be practiced in various forms without departing from the spirit and scope thereof. Besides, when a plurality of constituting elements of a plurality of embodiments are appropriately combined, various disclosures can be formed. For example, some constituting elements may be omitted from all of the constituting elements described in the embodiment. Furthermore, constituting elements of different embodiments may be appropriately combined. For easy understanding, the respective constituting elements are mainly schematically illustrated in the drawings, and the length, the number, the distance, and the like of each constituting element in the drawings are different from actual ones for convenience sake of preparing the drawings. Besides, the shape of each constituting element, the language, the symbol, and the like described in the aforementioned embodiment are not restrictive but illustrative, and can be variously changed substantially without departing from the configuration of the present disclosure.

(1) As described with reference to FIGS. 1A to 8, the receiving section 30 is a touch panel, which does not limit the present disclosure. The receiving section 30 may have any configuration as long as the symbol L can be input through the software keyboard image 21 in accordance with an operation performed by a user. For example, in an embodiment in which the symbol input device 1 is a personal computer, the receiving section 30 may be a mouse, or a display having a touch panel function.

(2) As described with reference to FIGS. 1A to 8, the symbol L input by a user is displayed in the input symbol display area 22, which does not limit the present disclosure. For example, when the input symbol display area 22 is for inputting a password, a user is required to highly accurately input the first phonogram L1 in the input symbol display area 22. In such an embodiment, the processor 10 preferably controls the display 20 to display the first software keyboard image 21A so that the user can easily visually recognize, on the keyboard, the symbol L desired to input.

What is claimed is:

1. A symbol input device comprising:
a display configured to display a software keyboard image and a symbol, the symbol being input through the software keyboard image;
a receiving section configured to receive a symbol input instruction; and
a processor configured to switchingly execute a non-conversion mode and a conversion mode, wherein
the symbol is input through the software keyboard image in accordance with the symbol input instruction,
the symbol includes a first phonogram and a second phonogram, the first phonogram representing a phonogram of a first language, the second phonogram representing a phonogram of a second language different from the first language,
the first phonogram includes a consonant character and a first vowel character,
the second phonogram includes a second vowel character corresponding to the first vowel character,
the non-conversion mode is a mode in which the first phonogram input in accordance with the symbol input instruction is displayed in the display,
the conversion mode is a mode in which the first phonogram input in accordance with the symbol input instruction is converted into the second phonogram corresponding to the first phonogram to be displayed in the display,
the software keyboard image includes a first software keyboard image and a second software keyboard image,
the first software keyboard image includes a consonant key image and a first vowel key image, the consonant image representing the consonant character, the first vowel key image representing the first vowel character,
the second software keyboard image includes the consonant key image and a second vowel key image, the second vowel key image representing the second vowel character instead of the first vowel key image, and
the processor controls the display to display the second software keyboard image in the conversion mode.

2. The symbol input device according to claim 1, wherein
the processor controls, in accordance with the symbol input instruction, the display to switch between the first software keyboard image and the second software keyboard image in the conversion mode.

3. The symbol input device according to claim 2, wherein
the symbol input instruction includes a consonant input instruction to input the consonant character, a first vowel input instruction to input the first vowel character, and a second vowel input instruction to input the second vowel character,
when the receiving section has received the consonant input instruction, the processor switches the second software keyboard image to the first software keyboard image,
when the receiving section has received the first vowel input instruction, the processor switches the first software keyboard image to the second software keyboard image, and
when the receiving section has received the second vowel input instruction, the processor maintains display of the second software keyboard image.

4. The symbol input device according to claim 2, wherein
the symbol input instruction includes a first input instruction to input the first phonogram, a second input instruction to input the second phonogram, and a punctuation input instruction to input a full stop or a comma,
when the receiving section has received the first input instruction or the second input instruction, the processor switches the second software keyboard image to the first software keyboard image, and
when the receiving section has received the punctuation input instruction, the processor switches the first software keyboard image to the second software keyboard image.

5. The symbol input device according to claim 2, wherein
when the receiving section has received the symbol input instruction, the processor switches the second software keyboard image to the first software keyboard image, and
when the receiving section has not received an additional symbol input instruction for a prescribed period of time after receiving the symbol input instruction, the processor switches the first software keyboard image to the second software keyboard image.

6. The symbol input device according to claim 2, wherein
the symbol input instruction includes a delete instruction to delete the symbol having been input, and
when the receiving section has received the delete instruction, the processor switches the first software keyboard image to the second software keyboard image.

7. The symbol input device according to claim 1, wherein
a form of the second vowel key image is different from a form of the first vowel key image.

8. The symbol input device according to claim 1, wherein
the first language is English,
the first phonogram is an English alphabet, and
the software keyboard image represents a software keyboard image of a QWERTY layout.

9. The symbol input device according to claim 1, wherein
the second language is Japanese,
the second phonogram is a Japanese kana character, and
the conversion mode is a romaji input mode.

10. The symbol input device according to claim 1, wherein
the first vowel character is plural in number,
the plural first vowel characters represent respective vowels different from one another,
the second vowel character is plural in number, and
the plural second vowel characters each correspond to a corresponding one of the plural first vowel characters.

11. A symbol input control method comprising causing a processor to execute:
switchingly executing a non-conversion mode and a conversion mode;
displaying a software keyboard image and a symbol input through the software keyboard image; and
receiving a symbol input instruction, wherein
the symbol is input through the software keyboard image in accordance with the symbol input instruction,
the symbol includes a first phonogram and a second phonogram, the first phonogram representing a phonogram of a first language, the second phonogram representing a phonogram of a second language different from the first language,
the first phonogram includes a consonant character and a first vowel character,
the second phonogram includes a second vowel character corresponding to the first vowel character,
the non-conversion mode is a mode in which the first phonogram input in accordance with the symbol input instruction is displayed in the displaying,
the conversion mode is a mode in which the first phonogram input in accordance with the symbol input instruction is converted into the second phonogram corresponding to the first phonogram to be displayed in the displaying,
the software keyboard image includes a first software keyboard image and a second software keyboard image,
the first software keyboard image includes a consonant key image and a first vowel key image, the consonant key image representing the consonant character, the first vowel key image representing the first vowel character,
the second software keyboard image includes the consonant key image and a second vowel key image, the second vowel key image representing the second vowel character instead of the first vowel key image, and
the switchingly executing is performed by displaying the second software keyboard image in the conversion mode.
